(19) United States
(12) Patent Application Publication
(10) Pub. No.: US 2026/0104486 A1
(43) Pub. Date: Apr. 16, 2026

(54) DEVICE AND SYSTEM FOR GENERATING CHIRP SIGNAL

(71) Applicant: SAMSUNG ELECTRONICS CO., LTD., Suwon-si (KR)

(72) Inventors: Kyung Woo YOO, Suwon-si (KR); Tae Woo YU, Suwon-si (KR); Doo Seok CHOI, Suwon-si (KR)

(73) Assignee: SAMSUNG ELECTRONICS CO., LTD., Suwon-si (KR)

(21) Appl. No.: 19/092,401

(22) Filed: Mar. 27, 2025

(30) Foreign Application Priority Data
Oct. 15, 2024 (KR) 10-2024-0140113

(51) Int. Cl. G01S 7/35; G01S 13/34

(52) U.S. Cl. CPC G01S 7/35; G01S 13/343

(57) ABSTRACT

A device for generating a signal includes a chirp signal generator configured to generate a chirp signal, one or more processors including processing circuitry, and a memory storing instructions. The instructions, when executed by the one or more processors individually or collectively, cause the device to receive a user parameter, control the chirp signal generator to generate the chirp signal having a maximum chirp bandwidth based on the user parameter, perform a first modeling operation of a chirp bandwidth based on an idle time between chirp pulses included in the chirp signal being fixed, perform a second modeling operation of the chirp bandwidth based on the idle time varying according to the chirp bandwidth, and determine the maximum chirp bandwidth based on the user parameter and a result of the second modeling operation.

### CROSS-REFERENCE TO RELATED APPLICATIONS

This application claims priority under 35 U.S.C. § 119 to Korean Patent Application No. 10-2024-0140113, filed on Oct. 15, 2024, in the Korean Intellectual Property Office, the disclosure of which is incorporated by reference herein in its entirety.

### BACKGROUND

### 1. Field

The present disclosure relates to a device and system for generating a chirp signal.

### 2. Description of Related Art

In radar systems, chirp bandwidth settings may be related to a range resolution capability. As such, it may be desirable to determine a maximum chirp bandwidth in consideration of a radar operation scenario and/or a parameter that may be supported by the radar, in order to potentially improve performance of the radar in, for example, high resolution applications such as, but not limited to, four-dimensional (4D) imaging radar (e.g., range, azimuth, elevation, and Doppler dimensions).

The chirp bandwidth may have a nonlinear correlation with various parameters of the radar system such as, but not limited to, a maximum detection range, a maximum Doppler (velocity), a start frequency of the chirp signal, an intermediate frequency (IF), an IF bandwidth, or an idle time that may be considered in the radar operation scenario.

The chirp bandwidth may be designed in consideration of the scenario in which a user may want to operate. However, when the user's purpose is to adaptively change the maximum detection range and/or the maximum Doppler in accordance with changes in peripheral situations and/or environments, related radar operation parameters may not be suitable in terms of power management and/or signal processing.

Thus, there exists a need to present an optimal radar sensor operation condition that provides a user with an ability to operate in various scenarios and/or in diverse situations so that the user may secure optimal detection performance that may be supported by a radar system.

### SUMMARY

One or more example embodiments of the present disclosure provide a device and system for generating a signal that may secure high range resolution to exhibit optimal performance in a produced operation environment.

Aspects of the present disclosure are not limited to the aspects mentioned above, and other aspects that are not mentioned may be clearly understood by those skilled in the art from the descriptions as set forth below.

According to an aspect of the present disclosure, a device for generating a signal includes a chirp signal generator configured to generate a chirp signal, one or more processors including processing circuitry, and a memory storing instructions. The instructions, when executed by the one or more processors individually or collectively, cause the device to receive a user parameter, control the chirp signal generator to generate the chirp signal having a maximum chirp bandwidth based on the user parameter, perform a first modeling operation of a chirp bandwidth based on an idle time between chirp pulses included in the chirp signal being fixed, perform a second modeling operation of the chirp bandwidth based on the idle time varying according to the chirp bandwidth, and determine the maximum chirp bandwidth based on the user parameter and a result of the second modeling operation.

According to an aspect of the present disclosure, a device for generating a signal includes one or more processors including processing circuitry, and a storage storing therein instructions. The instructions, when executed by the one or more processors individually or collectively, cause the device to receive a user parameter, perform a first modeling operation of a chirp bandwidth based on an idle time between chirp pulses included in a chirp signal being fixed, perform a second modeling operation of the chirp bandwidth in consideration of the idle time varying according to the chirp bandwidth, and determine a maximum chirp bandwidth based on the user parameter and a result of the second modeling operation.

According to an aspect of the present disclosure, a system for generating a signal includes an antenna, and a device for generating a chirp signal to be output through the antenna. The device for generating the chirp signal includes a chirp signal generator configured to generate the chirp signal, one or more processors including processing circuitry, and a memory storing instructions. The instructions, when executed by the one or more processors individually or collectively, cause the device to receive a user parameter, control the chirp signal generator to generate the chirp signal having a maximum chirp bandwidth based on the user parameter, perform a first modeling operation of a chirp bandwidth based on an idle time between chirp pulses included in the chirp signal being fixed, perform a second modeling operation of the chirp bandwidth based on the idle time varying according to the chirp bandwidth, and determine the maximum chirp bandwidth based on the user parameter and a result of the second modeling operation.

According to an aspect of the present disclosure, an operating method of a device for generating a signal includes receiving a user parameter, performing a first modeling operation of a chirp bandwidth based on an idle time between chirp pulses included in a chirp signal being fixed, performing a second modeling operation of the chirp bandwidth in consideration of the idle time varying according to the chirp bandwidth, determining a maximum chirp bandwidth based on the user parameter and a result of the second modeling operation, outputting, through an antenna, a chirp signal based on the maximum chirp bandwidth.

Additional aspects may be set forth in part in the description which follows and, in part, may be apparent from the description, and/or may be learned by practice of the presented embodiments.

### BRIEF DESCRIPTION OF THE DRAWINGS

The above and other aspects, features, and advantages of certain embodiments of the present disclosure will be apparent from the following description taken in conjunction with the accompanying drawings, in which:

FIG. 1 is a diagram illustrating a signal generating system, according to one or more embodiments;

FIG. 2 is a flowchart illustrating a method for calculating a maximum chirp bandwidth, according to one or more embodiments;

FIGS. 3 to 8 are diagrams illustrating a method for calculating the maximum chirp bandwidth of FIG. 2, according to one or more embodiments; and

FIG. 9 is a block diagram of an electronic device, according to one or more embodiments.

### DETAILED DESCRIPTION

The following description with reference to the accompanying drawings is provided to assist in a comprehensive understanding of embodiments of the present disclosure defined by the claims and their equivalents. Various specific details are included to assist in understanding, but these details are considered to be exemplary only. Therefore, those of ordinary skill in the art may recognize that various changes and modifications of the embodiments described herein may be made without departing from the scope and spirit of the disclosure. In addition, descriptions of well-known functions and structures are omitted for clarity and conciseness.

With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wired), wirelessly, or via a third element.

Reference throughout the present disclosure to “one embodiment,” “an embodiment,” “some embodiments”, “an example embodiment,” or similar language may indicate that a particular feature, structure, or characteristic described in connection with the indicated embodiment is included in at least one embodiment of the present solution. Thus, the phrases “in one embodiment”, “in an embodiment,” “in some embodiments”, “in an example embodiment,” and similar language throughout this disclosure may, but do not necessarily, all refer to the same embodiment. The embodiments described herein are example embodiments, and thus, the disclosure is not limited thereto and may be realized in various other forms.

It is to be understood that the specific order or hierarchy of blocks in the processes/flowcharts disclosed are an illustration of exemplary approaches. Based upon design preferences, it is understood that the specific order or hierarchy of blocks in the processes/flowcharts may be rearranged. Further, some blocks may be combined or omitted. The accompanying claims present elements of the various blocks in a sample order, and are not meant to be limited to the specific order or hierarchy presented.

The embodiments herein may be described and illustrated in terms of blocks, as shown in the drawings, which carry out a described function or functions. These blocks, which may be referred to herein as units or modules or the like, or by names such as device, logic, circuit, controller, counter, comparator, generator, converter, or the like, may be physically implemented by analog and/or digital circuits including one or more of a logic gate, an integrated circuit, a microprocessor, a microcontroller, a memory circuit, a passive electronic component, an active electronic component, an optical component, and the like.

In the present disclosure, the articles “a” and “an” are intended to include one or more items, and may be used interchangeably with “one or more.” Where only one item is intended, the term “one” or similar language is used. For example, the term “a processor” may refer to either a single processor or multiple processors. When a processor is described as carrying out an operation and the processor is referred to perform an additional operation, the multiple operations may be executed by either a single processor or any one or a combination of multiple processors.

Hereinafter, example embodiments of the present disclosure are described with reference to the accompanying drawings.

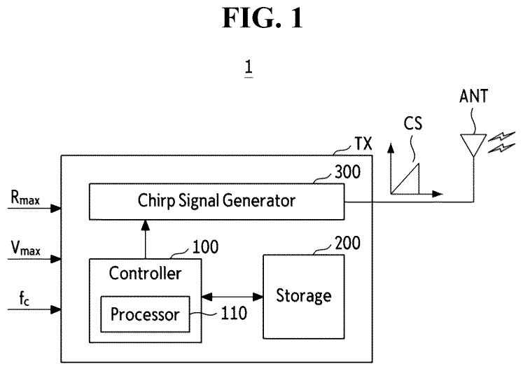

FIG. 1 is a diagram illustrating a signal generating system, according to one or more embodiments.

Referring to FIG. 1, a signal generating system 1 may include a device TX for generating a signal and an antenna ANT.

The device TX for generating the signal may generate a chirp signal CS output through the antenna ANT. In one or more embodiments, the device TX for generating the signal may be and/or may include a frequency modulated continuous wave (FMCW) radar device. However, the present disclosure is not limited thereto.

The device TX for generating the signal may include a chirp signal generator 300 and a controller 100.

The chirp signal generator 300 may generate a chirp signal CS under control of the controller 100.

The controller 100 may receive a user parameter, and may control the chirp signal generator 300 to generate the chirp signal CS having a maximum chirp bandwidth based on the user parameter.

The user parameter may include, for example, a maximum detection range Rₘₐₓ and a maximum detection Doppler value Vₘₐₓ of a target object to be detected using the chirp signal CS, and a start frequency f_{c} of the chirp signal CS. However, the present disclosure is not limited thereto.

The chirp signal generator 300 may have an intermediate frequency (IF) bandwidth defined therein for generating the chirp signal CS. When the controller 100 inputs the maximum distance and the maximum Doppler value of the target object that the user wants to detect, as indicated by the user parameter, the controller 100 may calculate the maximum chirp bandwidth at which the radar device (e.g., device TX) may operate, based on the defined IF bandwidth. In addition, the controller 100 may control the chirp signal generator 300 based on the maximum chirp bandwidth to generate the chirp signal CS.

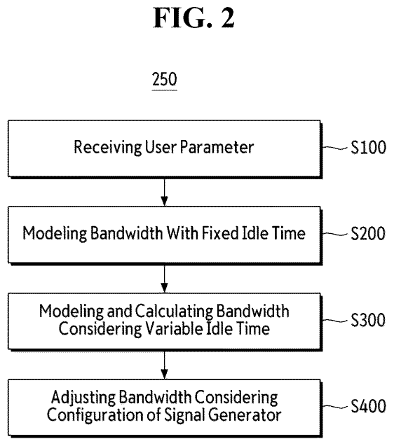

In this case, the available IF bandwidth of the chirp signal generator 300 may be utilized to a maximum extent, thereby maximizing resource efficiency. Operations of the controller are further described with reference to FIGS. 2 to 8.

In one or more embodiments, the controller 100 may include a processor 110. In one or more embodiments, the processor 110 may execute an instruction stored in storage 200. Thus, the controller 100 may calculate the maximum chirp bandwidth. However, the present disclosure is not limited thereto. In one or more embodiments, the controller 100 may calculate the maximum chirp bandwidth using hardware components included therein.

The controller 100 may include one or more processors, such as the processor 110. The processor 110 may be implemented in hardware, firmware, and/or a combination of hardware and software. For example, the processor 110 may include a central processing unit (CPU), an application processor (AP), a graphics processing unit (GPU), an accelerated processing unit (APU), a microprocessor, a microcontroller, a digital signal processor (DSP), a field-programmable gate array (FPGA), an application-specific integrated circuit (ASIC), an image signal processor (ISP), a neural processing unit (NPU), a communication processor (CP), an AI-dedicated processor designed to have a hardware structure specified to process an AI model, a general purpose single-chip and/or multi-chip processor, or other programmable logic device, discrete gate or transistor logic, discrete hardware components, or any combination thereof designed to perform the functions described herein. A general purpose processor may include a microprocessor, or any conventional processor, controller, microcontroller, or state machine.

The controller 100 may also be implemented as a combination of computing devices, such as a combination of a DSP and a microprocessor, a combination of a main processor and an auxiliary processor, a plurality of microprocessors, one or more microprocessors in conjunction with a DSP core, or any other such configuration. In one or more embodiments, particular processes and methods may be performed by circuitry that is specific to a given function. In optional or additional embodiments, an auxiliary processor may be configured to consume less power than the main processor. Alternatively or additionally, the one or more processors may be implemented separately (e.g., as several distinct chips) and/or may be combined into a single form.

The device TX may further include the storage 200. In one or more embodiments, the storage 200 may include volatile memory such as, but not limited to, random access memory (RAM), static RAM (SRAM), dynamic RAM (DRAM), or the like. In optional or additional embodiments, the storage 200 may include non-volatile memory such as, but not limited to, read only memory (ROM), electrically erasable programmable ROM (EEPROM), NAND flash memory, phase-change RAM (PRAM), magnetic RAM (MRAM), resistive RAM (RRAM), ferroelectric RAM (FRAM), magnetic memory, optical memory, or the like. However, the present disclosure is not limited in this regard, and the storage 200 may include other types of dynamic and/or static memory storage. In an embodiment, the storage 200 may store information and/or instructions for use (e.g., execution) by the controller 100 (e.g., processor 110).

The storage 200 may store information and/or computer-readable instructions and/or code related to the operation and use of the device TX. For example, the storage 200 may include a hard disk (e.g., a magnetic disk, an optical disk, a magneto-optic disk, and/or a solid state disk), a compact disc (CD), a digital versatile disc (DVD), a universal serial bus (USB) flash drive, a Personal Computer Memory Card International Association (PCMCIA) card, a floppy disk, a cartridge, a magnetic tape, and/or another type of non-transitory computer-readable medium, along with a corresponding drive.

Hereinafter, with reference to FIGS. 2 to 8, a method for calculating the maximum operable chirp bandwidth based on the defined IF bandwidth and the user parameter is described.

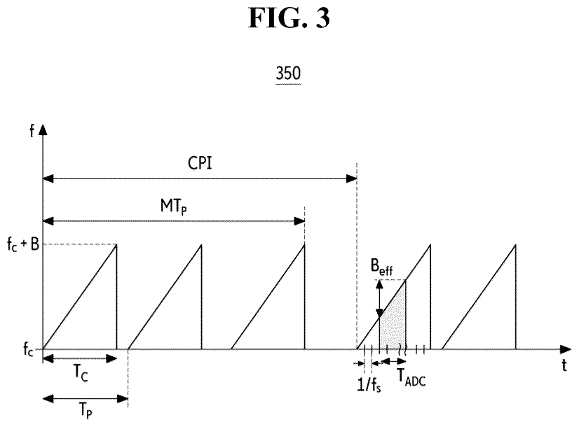

FIG. 2 is a flowchart illustrating a method 250 for calculating the maximum chirp bandwidth, according to one or more embodiments. FIGS. 3 to 8 are diagrams illustrating a method for calculating the maximum chirp bandwidth of FIG. 2, according to one or more embodiments.

Referring to operation S100 of FIG. 2, the user parameter may be received by the device TX.

For example, the user parameters may include the maximum detection range Rₘₐₓ and the maximum detection Doppler value Vₘₐₓ of the target object to be detected using the chirp signal CS, and the start frequency f_{c} of the chirp signal CS.

Continuing to refer to FIG. 2, a chirp bandwidth may be modeled, in operation S200, under an assumption that an idle time T_{Idle} between chirp pulses may be fixed.

Referring to FIG. 3, graph 350 illustrates parameters related to the chirp signal CS that may be generated by the device TX (e.g., a FMCW radar) may be represented as follows.

f_{c} may represent the starting frequency of the chirp signal, B may represent the chirp bandwidth, T_{c} may represent a width of the chirp pulse, and T_{P} may represent an interval (e.g., a pulse repetition interval (PRI)) at which the chirp pulse is repeated.

MT_{P} may represent the number of chirp pulses for Doppler compression, B_{eff} may represent the chirp bandwidth used in the actual signal processing, T_{ADC} may represent an observation time considered in the signal processing, fₛ may represent a sampling frequency (e.g., the sampling frequency of the chirp signal generator 300), and CPI may represent a coherent pulse interval.

A correlation between the maximum detection range Rₘₐₓ and the maximum detection Doppler value Vₘₐₓ received depending on the detection environment considered by the user and the chirp parameters as described above may be represented as an equation similar to Equation 1.

$${R}_{max} = \frac{c {N}_{R}}{2 {B}_{eff}} , {V}_{max} = \frac{c}{4 ( {f}_{c} + {B}_{eff} / 2 ) {T}_{P}} \qquad [ Equation 1 ]$$

Referring to Equation 1, c may represent the speed of light, and NR may represent the number of samples per chirp.

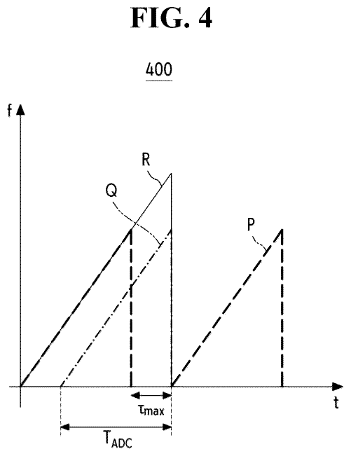

FIG. 4 is a diagram 400 illustrating a transmitted chirp signal P, a received signal Q reflected from the target object, and a de-chirp signal R obtained by extending the pulse width of the chirp signal.

Referring to FIG. 4, τₘₐₓ may represent a time delay of the signal reflected from the object at a distance of Rₘₐₓ, and may be represented as an equation similar to τₘₐₓ=2Rₘₐₓ/c. The pulse width of the de-chirp signal may have been set to T_{c}+τₘₐₓ, and T_{ADC} may represent a time between τₘₐₓ and T_{c}+τₘₐₓ, such that T_{ADC}=T_{c}. Consequently, B_{eff}=B may be satisfied.

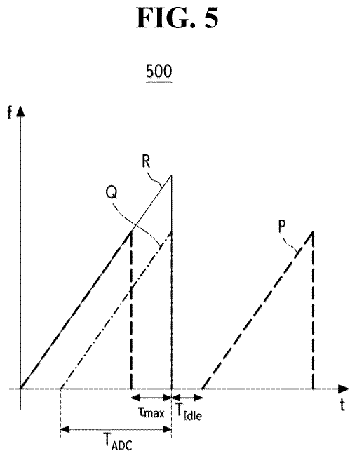

Furthermore, in order to generate the chirp signal in a relatively stable manner, the idle time between chirp pulses may need be set to a time between the chirp signals, and may be expressed as T_{Idle}, as shown in graph 500 of FIG. 5.

Thus, the pulse repetition interval T_{P} may be represented as an equation similar to Equation 2 as set forth below.

$${T}_{P} = {T}_{C} + {τ}_{max} + {T}_{Idle} \qquad [ Equation 2 ]$$

S may represent a chirp slope, and may be represented as an equation similar to S=B/T_{c}. The maximum IF f_{IF,max} that the radar device (e.g., device TX) may support may be represented as an equation similar to Equation 3.

$${f}_{IF , max} = {S}_{{τ}_{max}} \qquad [ Equation 3 ]$$

Therefore, the chirp bandwidth B may be represented as an equation similar to Equation 4.

$$B = S \times {T}_{C} = \frac{{f}_{IF , max}}{{τ}_{max}} \times ( {T}_{P} - {τ}_{max} - {T}_{Idle} ) \qquad [ Equation 4 ]$$

Equation 4 may be rewritten as an equation based on the maximum detection Doppler value Vₘₐₓ, and may be represented as an equation similar to Equation 5.

$$B = \frac{{f}_{IF , max}}{{τ}_{max}} \times ( \frac{c}{4 ( {f}_{c} + \frac{B}{2} ) {V}_{max}} - {τ}_{max} - {T}_{Idle} ) \qquad [ Equation 5 ]$$

A value to be derived from Equation 5 may be the chirp bandwidth B. Thus, Equation 5 may be rearranged based on the chirp bandwidth B, and the rearrangement result may be represented as an equation similar to Equation 6.

$$( {f}_{c} + \frac{B}{2} ) B = \frac{{f}_{IF , max}}{{τ}_{max}} ( \frac{c}{4 {V}_{max}} - ( {f}_{c} + \frac{B}{2} ) ( {τ}_{max} + {T}_{Idle} ) ) \qquad [ Equation 6 ]$$

$$\frac{1}{2} {B}^{2} + {f}_{c} B = \frac{{cf}_{IF , max}}{4 {V}_{max} {τ}_{max}} - \frac{{f}_{IF , max}}{{τ}_{max}} ( {f}_{c} + \frac{B}{2} ) ( {τ}_{max} + {T}_{Idle} )$$

$$\frac{1}{2} {B}^{2} + {f}_{c} B = \frac{{cf}_{IF , max}}{4 {V}_{max} {τ}_{max}} - \frac{{f}_{IF , max}}{{τ}_{max}} ( {τ}_{max} + {T}_{Idle} ) {f}_{c} - \frac{{f}_{IF , max}}{{τ}_{max}} ( {τ}_{max} + {T}_{Idle} ) \frac{B}{2}$$

$$\frac{1}{2} {B}^{2} + ( {f}_{c} + \frac{{f}_{IF , max}}{2 {τ}_{max}} ( {τ}_{max} + {T}_{Idle} ) ) B + \frac{{f}_{IF , max}}{{τ}_{max}} ( ( {τ}_{max} + {T}_{Idle} ) {f}_{c} - \frac{c}{4 {V}_{max}} ) = 0$$

Referring to Equation 6, the chirp bandwidth B may be represented as a second-order (e.g., quadratic) equation. Thus, the quadratic equation may be solved for the chirp bandwidth B, and the solution to the quadratic equation may be represented as an equation similar to Equation 7.

$$B = [ - ( {f}_{c} + \frac{{f}_{IF , max}}{2 {τ}_{max}} ( {τ}_{max} + {T}_{Idle} ) ) \pm \sqrt{{( {f}_{c} + \frac{{f}_{IF , max}}{2 {τ}_{max}} ( {τ}_{max} + {T}_{Idle} ) )}^{2} - 2 \frac{{f}_{IF , max}}{{τ}_{max}} ( ( {τ}_{max} + {T}_{Idle} ) {f}_{c} - \frac{c}{4 {V}_{max}} )} ] \qquad [ Equation 7 ]$$

However, since the chirp bandwidth B is positive, the solution to the quadratic equation may only be defined when ± is + in the Equation 7. When f_{IF,max}=γB_{IF} and τₘₐₓ is expressed as a function of the maximum detection range Rₘₐₓ, the chirp bandwidth B may be represented as an equation similar to Equation 8.

$$B = - ( {f}_{c} + \frac{c γ {B}_{IF}}{4 {R}_{max}} ( \frac{2 {R}_{max}}{c} + {T}_{Idle} ) ) + \sqrt{{( {f}_{c} + \frac{c γ {B}_{IF}}{4 {R}_{max}} ( \frac{2 {R}_{max}}{c} + {T}_{Idle} ) )}^{2} - \frac{c γ {B}_{IF}}{{R}_{max}} ( ( \frac{2 {R}_{max}}{c} + {T}_{Idle} ) {f}_{c} - \frac{c}{4 {V}_{max}} )} \qquad [ Equation 8 ]$$

Referring to Equation 8, B_{IF} may represent, for example, the IF bandwidth in consideration of filter characteristics of the chirp signal generator 300. In this regard, the frequency characteristics may deteriorate at an edge of the filter bandwidth. Thus, a scaling factor γ (e.g., 0<γ<1) may be defined to assume that processing may be performed on a signal within a range where an ideal frequency response may be guaranteed.

In one or more embodiments, γ may be set to about 0.9. However the present disclosure is not limited in this regard, and a value thereof may vary depending on filter design constraints.

Based on Equation 8, the maximum B (e.g., the range resolution ΔR=c/2B) at which the chirp signal may be transmitted may be determined based on the IF bandwidth that may be supported by the radar device (e.g., device TX) and the user parameter (e.g., the start frequency f_{c}, the maximum detection range Rₘₐₓ, and the maximum detection Doppler value Vₘₐₓ) input by the user according to the scenario set by the user.

By calculating the chirp bandwidth B in such a manner, the maximum IF of the received signal may be equal to f_{IF,max} even when the maximum detection range Rₘₐₓ and/or maximum detection Doppler value Vₘₐₓ change. Consequently, all range bins of a fast Fourier transform (FFT) may be populated within a considered region.

Returning to FIG. 2, the chirp bandwidth B may be modeled and calculated in consideration of the idle time T_{Idle} between the chirp pulses that may vary depending on the chirp bandwidth B, in operation S300.

Equation 8 may refer to the result under an environment where the idle time T_{Idle} may be a fixed value. In general, as the chirp bandwidth B increases, a difference between an end frequency of a previous chirp pulse and a start frequency of a next chirp pulse may also increase. Thus, a larger idle time T_{Idle} may be needed.

However, when the idle time T_{Idle} is defined as a function of the chirp bandwidth B, the chirp bandwidth B may not be derived using only the Equations 1 to 8 as described above. Therefore, in an embodiment, a method for modeling and calculating the chirp bandwidth in a situation where the idle time T_{Idle} changes depending on the chirp bandwidth B is described.

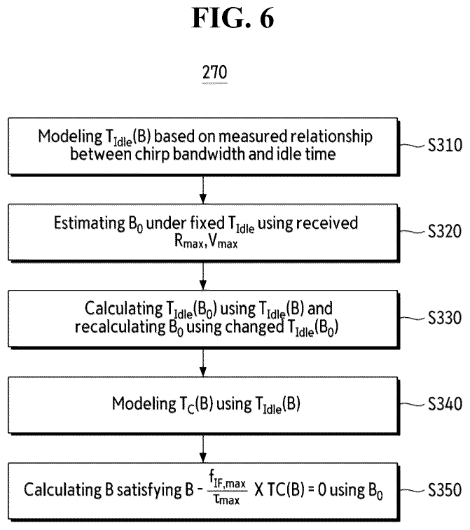

FIG. 6 is a flowchart illustrating a method 270 for modeling and calculating the chirp bandwidth in a situation where the idle time T_{Idle} changes depending on the chirp bandwidth B, according to one or more embodiments.

Referring to FIG. 6, in operation S310, a relationship between the chirp bandwidth B and the idle time T_{Idle} between the chirp pulses may be defined using the measurement of the idle time T_{Idle} between chirp pulses as needed based on the chirp bandwidth B.

For example, a relationship of T_{Idle}(B) may be defined (e.g., modeled) using the measurement of the idle time T_{Idle} between chirp pulses needed based on the chirp bandwidth B of a designed element. In an embodiment, the correlation between the chirp bandwidth B and the idle time T_{Idle} between the chirp pulses may be assumed to be a linear relationship, and the relationship may be represented as an equation similar to Equation 9.

$${T}_{Idle} ( B ) = \frac{Δ τ}{Δ B} ( \frac{{T}_{C} + {τ}_{max}}{{T}_{C}} B - {B}_{d efault} ) + {τ}_{d efault} \qquad [ Equation 9 ]$$

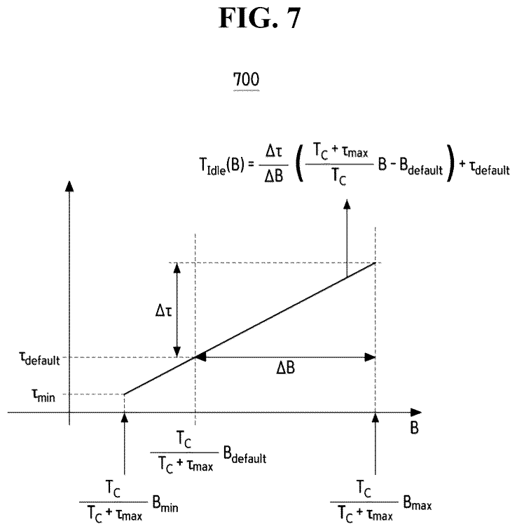

Referring to Equation 9, the parameters Δτ, ΔB, B_{default}, and τ_{default} may be defined as shown in graph 700 of FIG. 7.

For example, when B_{default} is 1 gigahertz (GHz), τ_{default} is 2 microseconds (μs), the chirp bandwidth of the de-chirp signal is 4 GHz, and the idle time T_{Idle} between chirp pulses is 8 μs, ΔB and Δτ may be set to 3 GHz and 6 μs, respectively. However, the present disclosure is not limited in this regard, and the parameters Δτ, ΔB, B_{default}, and τ_{default} may be set to other values without departing from the scope of the present disclosure.

Returning to FIG. 6, an initial chirp bandwidth B₀ may be calculated using the Equation 8, in operation S320.

That is, the initial chirp bandwidth B₀ value may be calculated based on the quadratic formula derived through Equation 8 as set forth above. The idle time T_{Idle} between chirp pulses at this time may be set to a median value of the idle time range used in the radar device (e.g., device TX).

In operation S330, B₀ may be updated using the relationship of T_{Idle}(B) as described with reference to operation S310 and to FIG. 7.

The chirp bandwidth may be calculated again using T_{Idle}(B₀) obtained by inputting the initial chirp bandwidth B₀ calculated in operation S320 to the relationship defined in operation S310, and the initial chirp bandwidth B₀ may be updated based on the calculation result.

Continuing to refer to FIG. 6, the width of the chirp pulse T_{c} may be represented as a function of chirp bandwidth B in operation S340.

For example, when the width of the chirp pulse T_{c} is expressed based on T_{Idle}(B), as represented by Equation 9, the width of the chirp pulse T_{c} may be represented as an equation similar to Equation 10.

$${T}_{C} = {T}_{P} - {τ}_{max} - {T}_{Idle} ( B ) = {T}_{P} - {τ}_{max} - \frac{Δτ}{Δ B} ( \frac{{T}_{C} + {τ}_{max}}{{T}_{C}} B - {B}_{default} ) - {τ}_{default} \qquad [ Equation 10 ]$$

A value to be derived from Equation 10 may be the width of the chirp pulse T_{c}. Thus, Equation 10 may be rearranged based on the chirp pulse T_{c}, and the rearrangement result may be represented as an equation similar to Equation 11.

$${T}_{C} = {T}_{P} - \frac{Δτ}{Δ B} \frac{{τ}_{max}}{{T}_{C}} B - \frac{Δτ}{Δ B} ( B - {B}_{default} ) - {τ}_{default} - {τ}_{max} \qquad [ Equation 11 ]$$

$${T}_{C} + \frac{Δτ}{Δ B} \frac{{τ}_{max}}{{T}_{C}} B + \frac{Δτ}{Δ B} ( B - {B}_{default} ) + {τ}_{default} - {τ}_{max} - {T}_{P} = 0$$

$${T}_{C}^{2} + ( \frac{Δτ}{Δ B} ( B - {B}_{default} ) + {τ}_{default} - {τ}_{max} - {T}_{P} ) {T}_{c} + \frac{{Δττ}_{max} B}{Δ B} = 0$$

Referring to Equation 11, the chirp pulse T_{c} may be represented as a second-order (e.g., quadratic) equation. Thus, the quadratic equation may be solved for the chirp pulse T_{c}, and the solution to the quadratic equation may be represented as an equation similar to Equation 12.

$${T}_{C} = \frac{1}{2} \text{} [ \begin{matrix}{T}_{P} - ( \frac{Δτ}{Δ B} ( B - {B}_{default} ) + {τ}_{default} + {τ}_{max} ) \pm \\ \sqrt{{( {T}_{P} - \text{} ( \begin{matrix}\frac{Δτ}{Δ B} ( B - {B}_{default} ) + \\ {τ}_{default} + {τ}_{max}\end{matrix} \text{} ) )}^{2} - 4 \frac{{Δττ}_{max} B}{Δ B}}\end{matrix} ] \text{} \qquad [ Equation 12 ]$$

Referring to Equation 12, T_{c} may have a value approximately to

$${T}_{P} - ( \frac{Δτ}{Δ B} ( B - {B}_{default} ) + {τ}_{default} + {τ}_{max} ) .$$

Thus, only when ± is +, a valid solution to the chirp pulse T_{c} may be obtained.

When the pulse repetition interval T_{P} is expressed as a function of the chirp bandwidth B, a final chirp pulse T_{c} may be represented as an equation similar to Equation 13.

$${T}_{C} = \frac{1}{2} [ \frac{C}{4 ( {f}_{c} + \frac{B}{2} ) {V}_{max}} - ( \begin{matrix}\frac{Δτ}{Δ B} ( B - {B}_{default} ) + \\ {τ}_{default} + {τ}_{max}\end{matrix} ) + \sqrt{{( \frac{C}{4 ( {f}_{c} + \frac{B}{2} ) {V}_{max}} - ( \begin{matrix}\frac{Δτ}{Δ B} ( B - {B}_{default} ) + \\ {τ}_{default} + {τ}_{max}\end{matrix} ) )}^{2} - 4 \frac{{Δττ}_{max} B}{Δ B}} ] \qquad [ Equation 13 ]$$

Referring to Equation 13, the chirp pulse T_{c} may be represented as a function of the chirp bandwidth B, T_{c}(B), since the variable on the right side of the equation is the chirp bandwidth B.

Returning to FIG. 6, in operation S350, a chirp bandwidth B that satisifies

$$B - \frac{{f}_{IF , max}}{{τ}_{max}} \times {T}_{C} ( B ) = 0$$

may be calculated using B₀ as the initial value.

In an embodiment, the chirp bandwidth B may be calculated in operation S350 using an equation that may be represented by an equation similar to Equation 14, and may be different from an equation used in operation S320.

$$B - \frac{{f}_{IF , max}}{{τ}_{max}} {T}_{C} ( B ) \qquad [ Equation 14 ]$$

When the Equation 14 is expressed as

$$g ( B ) = B - \frac{{f}_{IF , max}}{{τ}_{max}} {T}_{C} ( B ) ,$$

a zero-finding problem to calculate the chirp bandwidth B that satisfies g(B)=0 may need to be solved. Since g(B) and B may have a nonlinear relationship, an iterative method such as, but not limited to, the Newton method, as set forth below may be used to estimate the chirp bandwidth B.

$${g ( B ) ≃ g ( {B}_{ini} ) + \frac{dg ( B )}{dB} \vert}_{B = {B}_{ini}} ( B - {B}_{ini} ) = 0 \qquad [ Equation 15 ]$$

$${{B = {B}_{ini} - g ( {B}_{ini} ) ( \frac{dg ( B )}{dB} \vert}_{B = {B}_{ini}} )}^{- 1}$$

An initial Bᵢₙᵢ may be substituted with B₀, and a newly calculated chirp bandwidth B may be updated with Bᵢₙᵢ again and the process is repeated. A termination condition of the repetition may be set as

$${{g ( {B}_{ini} ) ( \frac{dg ( B )}{dB} \vert}_{B = {B}_{ini}} )}^{- 1} < ε$$

(where ε is a preset infinitesimal value).

In an embodiment, when the change in the idle time T_{Idle} between chirp pulses based on the chirp bandwidth B is considered, the maximum chirp bandwidth at which the radar device (e.g., device TX) may operate under the given environmental condition may be calculated.

A method of calculating B that satisfies g(B)=0 may be considered from the beginning. However, in this case, there may be no information about the chirp bandwidth B, and as such, it may be difficult to select an appropriate initial value. Therefore, in an embodiment, when an initial chirp bandwidth B₀ that is proximate to the chirp bandwidth B is pre-estimated first, a convergence speed to calculate the chirp bandwidth B may be increased. Thus, an amount of calculation may be reduced through a simple line calculation.

However, when the relationship between the chirp bandwidth B and the idle time T_{Idle} is not linear, as in the T_{Idle}(B) described above, the width of the chirp pulse T_{c} may not be able to be represented as a quadratic formula. In this case, T_{Idle}(B) may be modeled to have a nonlinear relationship relative to the chirp bandwidth B, the width of the chirp pulse T_{c} may be as a function of the idle time T_{Idle} (e.g., T_{c}(B)=T_{P}-τₘₐₓ-T_{Idle}(B)), and the chirp bandwidth B may be derived via calculation of

$${\frac{dg ( B )}{dB} \vert}_{B = {B}_{ini}}$$

based on the nonlinear relationship. That is,

$${\frac{dg ( B )}{dB} \vert}_{B = {B}_{ini}}$$

based on T_{Idle}(B) may be applied, such that the chirp bandwidth B may be derived. Further, the width of the chirp pulse T_{c} and the pulse repetition interval T_{P} may be derived based on the chirp bandwidth B related thereto.

Using this scheme, when the parameter defined by the user has been changed to the maximum detection range Rₘₐₓ and the range resolution, g(B) may be changed to g(Vₘₐₓ) and the maximum possible Doppler value Vₘₐₓ and the corresponding width of the chirp pulse T_{c} and pulse repetition interval T_{P} may be calculated.

In one example, when the calculated chirp bandwidth B is smaller than or equal to a chirp slope that may be supported by the chirp signal generator (e.g., the chirp signal generator 300), the chirp bandwidth B may be set as the chirp bandwidth, and the chirp bandwidth may be re-calculated based on the maximum possible chirp slope chirp slope when the final calculated B requires a chirp slope that is outside a chirp slope range that may be supported by the chirp signal generator 300.

In an embodiment, the maximum number of analog-digital converter (ADC) samples that may be stored in the chirp signal generator 300 may also be considered as a limitation in setting the chirp bandwidth.

Aspects of the present disclosure provide for, based on the user parameter and the configuration of the chirp signal generator 300, when the maximum detection range Rₘₐₓ, the maximum detection Doppler value Vₘₐₓ, and the IF bandwidth B_{IF} have been set, calculating the minimum idle time T_{Idle}, and the corresponding maximum chirp bandwidth B.

In an embodiment, the number of ADC samples may be determined based on a multiplication result between the sampling frequency fₛ of the chirp signal generator 300 and the width T_{c} of the chirp pulse. When the determined number of ADC samples is larger than the maximum size N_{ADC} of the memory that stores therein the sample signal of the chirp signal generator 300, the user parameter may need to be reset.

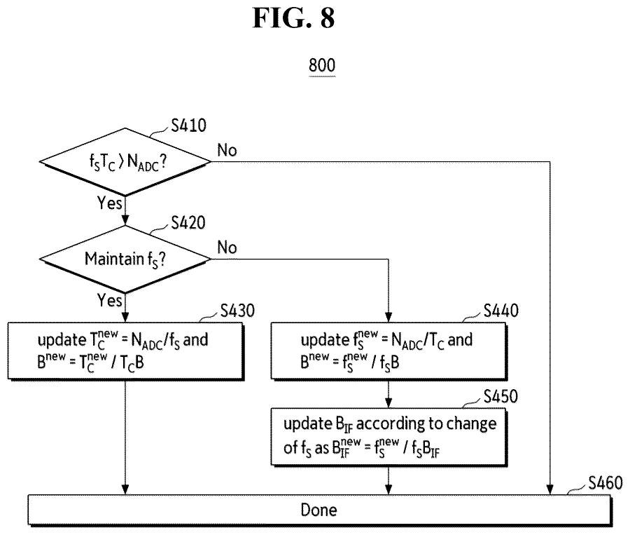

FIG. 8 is a flowchart illustrating a method 800 for method for calculating the maximum chirp bandwidth, according to one or more embodiments.

Referring to FIG. 8, in operation S410, the method 800 identifies whether the multiplication result between the sampling frequency fₛ of the chirp signal generator 300 and the width T_{c} of the chirp pulse is larger (greater) than the size N_{ADC} of the memory of the chirp signal generator 300 that stores therein the sample signal.

Based on a determination that the multiplication result is smaller (less) than or equal to the memory size (No in operation S410), no parameter reset may be needed and the method 800 may terminate. Thus, a previously determined maximum chirp bandwidth may not need to be further adjusted in operation S460.

Based on a determination that the multiplication result is larger (greater) than the memory size (Yes in operation S410—Yes), the method 800 may proceed to operation S410 to determine whether the sampling frequency fₛ is to be maintained.

Based on a determination to maintain the sampling frequency fₛ (Yes in operation S420), the method 800 may proceed to operation S430. In operation S430, the width T_{c} of the chirp pulse and the chirp bandwidth B may be reset using an equation similar to Equation 16.

$${T}_{C}^{new} = \frac{{N}_{ADC}}{{f}_{s}} , {B}^{new} = \frac{{T}_{C}^{new}}{{T}_{C} B} \qquad [ Equation 16 ]$$

Based on a determination not to maintain the sampling frequency fₛ (No in operation S420—No), the method 800 may proceed to operation S440. In operation S440, the sampling frequency fₛ and the chirp bandwidth B may be reset using an equation similar to Equation 17.

$${f}_{s}^{new} = \frac{{N}_{ADC}}{{T}_{c}} , {B}^{new} = \frac{{f}_{s}^{new}}{{f}_{s} B} \qquad [ Equation 17 ]$$

In operation S450, as the sampling frequency fₛ has been changed, the IF bandwidth B_{IF} may also be reset using an equation similar to Equation 18.

$${B}_{IF}^{n e w} = \frac{{f}_{s}^{n e w}}{{f}_{s} {B}_{IF}} \qquad [ Equation 18 ]$$

In an embodiment, when the maximum detection range Rₘₐₓ and the maximum detection Doppler Vₘₐₓ according to the user's purpose are input to the device for generating the signal, the device TX may be configured to derive the maximum chirp bandwidth at which the radar device (e.g., device TX) may operate, in consideration of the maximum IF bandwidth B_{IF} that may be supported by the device TX for generating the signal, the maximum IF f_{IF,max} based on the filter characteristics of the device for generating the signal, the maximum chirp slope S, the relationship T_{Idle}(B) between the chirp bandwidth and the idle time between chirp pulses, and the maximum number NR of ADC samples that may be stored in the device for generating the signal.

According to aspects of the present disclosure, when the radar device (e.g., device TX) provides the user with the maximum chirp bandwidth that may be supported by the radar device under various operation scenarios, the radar device may adaptively respond to scenarios that the user may not have initially considered. Thus, the device may exhibit optimal performance in the produced operation environment, when compared to related radar devices.

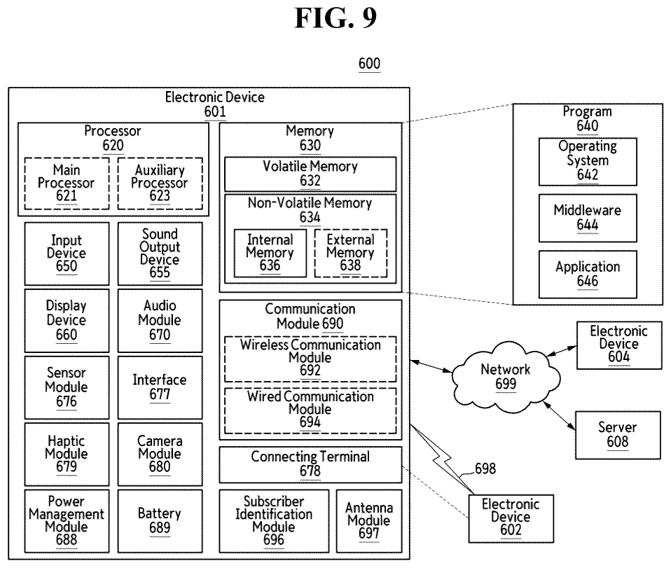

FIG. 9 is a block diagram of an electronic device, according to one or more embodiments.

Referring to FIG. 9, an electronic device 601 in a network environment 600 may communicate with an electronic device 602 over a first network 698 (e.g., a short-range wireless communication network), and/or may communicate with an electronic device 604 and/or a server 608 over a second network 699 (e.g., a long-range wireless communication network). In one or more embodiments, the electronic device 601 may be and/or may include, for example, a notebook computer, a laptop computer, a portable mobile terminal, or the like. However, the present disclosure is not limited thereto.

The electronic device 601 may communicate with the electronic device 604 via the server 608. The electronic device 601 may include a processor 620, memory 630, an input device 650, a sound output device 655, an image display device 660, an audio module 670, a sensor module 676, an interface 677, a haptic module 679, a camera module 680, a power management module 688, a battery 689, a communication module 690, a subscriber identification module (SIM) 696, or an antenna module 697.

The number and arrangement of components of the electronic device 601 shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Alternatively or additionally, a set of (one or more) components shown in FIG. 9 may be integrated with each other, and/or may be implemented as an integrated circuit, as software, and/or a combination of circuits and software. For example, at least one of components such as, but not limited to, the display device 660 or the camera module 680, may be omitted from the electronic device 601, and/or at least one further component may be added to the electronic device 601.

In one or more embodiments, some of the components may be implemented as a single integrated circuit (IC). For example, the sensor module 676 such as, but not limited to, a fingerprint sensor, an iris sensor, or an illuminance sensor, may be embedded in an image display device 660 such as, but not limited to, a display.

The processor 620 may execute software (e.g., a program 640) that may control other components of the at least one electronic device 601 such as, but not limited to, a hardware and/or software component connected to the processor 620 to perform various data processing and/or computations.

Based on the data processing and/or at least some of computations, the processor 620 may load a command and/or data received from another component such as, but not limited to, the sensor module 676 or the communication module 690, into a volatile memory 632, and process the command and/or data stored in the volatile memory 632, and store resulting data in a non-volatile memory 634.

The processor 620 may include, for example, a main processor 621, such as, but not limited to, a central processing unit (CPU) or an application processor (AP), and an auxiliary processor 623 operating independently of the main processor 621 or in connection with the main processor 621.

The auxiliary processor 623 may include, for example, a graphic processing unit (GPU), an image signal processor (ISP), a sensor hub processor, or a communication processor (CP), or the like.

In one or more embodiments, the auxiliary processor 623 may be configured to consume less power than that of the main processor 621 and/or to perform certain functions. The auxiliary processor 623 may be separate from the main processor 621 or may be implemented as a portion thereof.

The auxiliary processor 623 may control at least some of functions and/or states related to at least one of the components of the electronic device 601 on behalf of the main processor 621 while the main processor 621 is inactive, and/or together with the main processor 621 while the main processor 621 is active.

The memory 630 may store therein various data used in at least one component of the electronic device 601. The various data may include, for example, software such as the program 640, and input data and output data for related commands. However, the present disclosure is not limited in this regard. The memory 630 may include the volatile memory 632 and the non-volatile memory 634. The non-volatile memory 634 may include an internal memory 636 and an external memory 638.

The program 640 may be stored as software in the memory 630, and may include, for example, an operating system (OS) 642, middleware 644, or an application 646.

The input device 650 may receive a command and/or data to be used for other components of the electronic device 601 from a device external to the electronic device 601. The input device 650 may include, for example, a microphone, mouse, or keyboard. However, the present disclosure is not limited in this regard.

The sound output device 655 may output a sound signal out of the electronic device 601. The sound output device 655 may include, for example, a speaker or a receiver. The speaker may be used for general purpose of playing multimedia or recording a sound. The receiver may be used to receive an incoming call.

The image display device 660 may visually provide information out of the electronic device 601. The image display device may include, for example, a display, a hologram device, or a projector, and a control circuit for controlling a corresponding one of the display, the hologram device, or the projector. However, the present disclosure is not limited in this regard.

In one or more embodiments, the image display device 660 may include a touch circuit configured to detect a touch, and/or a sensor circuit configured to measure intensity of a force induced by the touch, for example, a pressure sensor.

The audio module 670 may convert a sound into an electrical signal or vice versa. In one or more embodiments, the audio module 670 may obtain a sound via the input device 650 and/or output the sound via the sound output device 605 and/or a headphone of an external electronic device 602 directly and/or wirelessly connected to the electronic device 601.

The sensor module 676 may detect, for example, an operating state of the electronic device 601 such as, but not limited to, output or temperature, or an environmental state external to the electronic device 601 such as, but not limited to, a user's state, and may generate an electrical signal or data corresponding to the detected state. The sensor module 676 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor. However, the present disclosure is not limited in this regard.

In one or more embodiments, the sensor module 676 may include a distance detection sensor, which may include the device TX for generating the signal as described with reference to FIGS. 1 to 8.

The interface 677 may support at least one prescribed protocol to be used by the electronic device 601 directly and/or wirelessly connected to the external device 602. In one or more embodiments, the interface 677 may include, for example, a high definition multimedia interface (HDMI), an universal serial bus (USB) interface, a secure digital (SD) card interface, or a voice interface. However, the present disclosure is not limited in this regard

A connection terminal 678 may include a connector through which the electronic device 601 may be physically connected to the external electronic device 602. In one or more embodiments, the connection terminal 678 may include, for example, an HDMI connector, a USB connector, an SD card connector, or a voice connector such as a headphone connector.

The haptic module 679 may convert an electrical signal into a mechanical stimulus, for example, vibration or motion, which may be recognized by a user via a haptic sensation or a kinesthetic sensation. In one or more embodiments, the haptic module 679 may include, for example, a motor, a piezoelectric element, or an electrical stimulator.

The camera module 680 may capture still images and/or moving images. In one or more embodiments, the camera module 680 may include at least one lens, an image sensor, an image signal processor, or a flash. However, the present disclosure is not limited in this regard.

The power management module 688 may manage power supplied to the electronic device 601. The power management module may be implemented, for example, as at least a portion of a power management integrated circuit (PMIC).

The battery 689 may supply power to at least one component of the electronic device 601. According to an embodiment, the battery 689 may include, for example, a non-rechargeable primary battery, a rechargeable secondary battery, or a fuel cell.

The communication module 690 may support establishment of a direct communication channel or a wireless communication channel between the electronic device 601 and an external electronic device such as, for example, the electronic device 602, the electronic device 604, or the server 608, and communicate therewith via the established communication channel.

The communication module 690 may operate independently of the processor 620, and may include at least one communication processor supporting direct communication or wireless communication.

In one or more embodiments, the communication module 690 may include, for example, a wireless communication module 692 such as, but not limited to, a mobile communication (cellular communication module), a short-range wireless communication module, or a global navigation satellite system (GNSS) communication module, or a wired communication module 694 such as a local area network (LAN) communication module, or a power line communication (PLC) module.

A corresponding communication module among these communication modules may communicate with an external electronic device over the first network 698 such as, for example, Bluetooth™, Wireless-Fidelity (Wi-Fi), Wi-Fi direct (WFD), Institute of Electrical and Electronics Engineers (IEEE) 802.11, Infrared Data Association (IrDA), or the second network 699 such as, for example, the mobile communication network, the Internet, and the long-range communication network.

These various types of communication modules may be implemented, for example, as a single component or as a plurality of components separated from each other. The wireless communication module 692 may use, for example, subscriber information such as, but not limited to, international mobile subscriber identity (IMSI) stored in the user identification module 696 to identify and/or authenticate the electronic device 601 in a communication network such as, but not limited to, the first network 698 and/or the second network 699.

The antenna module 697 may transmit and/or receive a signal and/or power to and/or from a device external to the electronic device 601. In one or more embodiments, the antenna module 697 may include at least one antenna. Thus, at least one antenna suitable for a communication scheme used in a communication network such as the first network 698 and/or the second network 699 may be selected by the communication module 690. The signal and/or power may be transmitted and/or received between the communication module and the external electronic device via the selected at least one antenna.

At least some of the aforementioned components may be interconnected to each other, and may communicate a signal therebetween in an inter-peripheral communication scheme such as, for example, a bus, a general purpose input and output (GPIO), a serial peripheral interface (SPI), or a mobile industry processor interface (MIPI).

In one or more embodiments, the command and/or data may be transmitted and/or received between the electronic device 601 and the external electronic device 604 via the server 608 connected to the second network 699. Each of the electronic devices 602 and 604 may be of the same type as or a different type from that of the electronic device 601. All or some of the operations to be executed on the electronic device 601 may be executed on at least one external electronic device 602, 604, or 608. For example, all or some of the operations to be executed on the electronic device 601 may be executed on at least one external electronic device 602, 604, or 608.

For example, when the electronic device 601 is configured to perform a function and/or service automatically or in response to a request from a user or other device, the electronic device 601 executing the function or service may request at least one external electronic device to perform at least a portion of the function or service instead or in addition to the device 601. At least one external electronic device that has received the request may perform at least a portion of the requested function or service or an additional function or additional service related to the request, and transmit a result of the execution to the electronic device 601. The electronic device 601 may provide the result as at least a portion of a response to the request with or without further processing of the result. For this purpose, for example, cloud computing, distributed computing, or client-server computing technologies may be used.

Although certain example embodiments of the present disclosure have been described with reference to the accompanying drawings, the present disclosure is not limited to the above embodiments, but may be implemented in various different forms. A person skilled in the art may appreciate that the present disclosure may be practiced in other concrete forms without changing the technical spirit or essential characteristics of the present disclosure. Therefore, it may be appreciated that the embodiments as described above are not restrictive but illustrative in all respects.

1. A device for generating a signal, the device comprising:
a chirp signal generator configured to generate a chirp signal;
one or more processors comprising processing circuitry; and
memory storing instructions,
wherein the instructions, when executed by the one or more processors individually or collectively, cause the device to:
receive a user parameter; and
control the chirp signal generator to generate the chirp signal having a maximum chirp bandwidth based on the user parameter,
wherein the instructions, when executed by the one or more processors individually or collectively, further cause the device to:
perform a first modeling operation of a chirp bandwidth based on an idle time between chirp pulses included in the chirp signal being fixed;
perform a second modeling operation of the chirp bandwidth based on the idle time varying according to the chirp bandwidth; and
determine the maximum chirp bandwidth based on the user parameter and a result of the second modeling operation.

2. The device of claim 1, wherein the user parameter comprises at least one of a maximum detection range of a target object to be detected using the chirp signal, a maximum detection Doppler value of the target object, or a start frequency of the chirp signal.

3. The device for generating the signal of claim 1, wherein the instructions, when executed by the one or more processors individually or collectively, further cause the device to:
define a relationship between the chirp bandwidth and the idle time between the chirp pulses, based on a measurement of the idle time required based on the chirp bandwidth;
set a width of the chirp pulses as a function of the chirp bandwidth, based on the defined relationship; and
perform the second modeling operation based on the width.

4. The device of claim 3, wherein the instructions, when executed by the one or more processors individually or collectively, further cause the device to:
determine an initial chirp bandwidth based on a result of the first modeling operation;
update the initial chirp bandwidth, based on the initial chirp bandwidth and the defined relationship; and
determine the maximum chirp bandwidth based on the user parameter, the updated initial chirp bandwidth, and the result of the second modeling operation.

5. The device of claim 1, wherein the instructions, when executed by the one or more processors individually or collectively, further cause the device to:
adjust the maximum chirp bandwidth based on a configuration of the chirp signal generator.

6. The device of claim 5, wherein the instructions, when executed by the one or more processors individually or collectively, further cause the device to:
compare a multiplication result between a sampling frequency of the chirp signal generator and a width of the chirp pulses with a size of a memory of the chirp signal generator; and
adjust the maximum chirp bandwidth based on a result of the comparison.

7. The device of claim 6, wherein the instructions, when executed by the one or more processors individually or collectively, further cause the device to:
reduce the maximum chirp bandwidth by reducing the width of the chirp pulses and maintaining the sampling frequency.

8. The device of claim 6, wherein the instructions, when executed by the one or more processors individually or collectively, further cause the device to:
reduce the maximum chirp bandwidth by reducing the sampling frequency and maintaining the width of the chirp pulses.

9.-16. (canceled)

17. A system for generating a signal, the system comprising:
an antenna; and
a device for generating a chirp signal to be output through the antenna,
wherein the device for generating the chirp signal comprises:
a chirp signal generator configured to generate the chirp signal;
one or more processors comprising processing circuitry; and
a memory storing instructions,
wherein the instructions, when executed by the one or more processors individually or collectively, cause the device to:
receive a user parameter; and
control the chirp signal generator to generate the chirp signal having a maximum chirp bandwidth based on the user parameter,
wherein the instructions, when executed by the one or more processors individually or collectively, further cause the device to:
perform a first modeling operation of a chirp bandwidth based on an idle time between chirp pulses included in the chirp signal being fixed;
perform a second modeling operation of the chirp bandwidth based on the idle time varying according to the chirp bandwidth; and
determine the maximum chirp bandwidth based on the user parameter and a result of the second modeling operation.

18. The system of claim 17, wherein the user parameter comprises at least one of a maximum detection range of a target object to be detected using the chirp signal, a maximum detection Doppler value of the target object, or a start frequency of the chirp signal.

19. The system of claim 17, wherein the instructions, when executed by the one or more processors individually or collectively, further cause the device to:
define a relationship between the chirp bandwidth and the idle time between the chirp pulses, based on a measurement of the idle time based on the chirp bandwidth;
set a width of the chirp pulses as a function of the chirp bandwidth, based on the defined relationship; and
perform the second modeling operation based on the width.

20. The system of claim 17, wherein the instructions, when executed by the one or more processors individually or collectively, further cause the device to:
adjust the maximum chirp bandwidth based on a configuration of the chirp signal generator.

21. An operating method of a device for generating a signal, the operating method comprising:
receiving a user parameter;
performing a first modeling operation of a chirp bandwidth based on an idle time between chirp pulses included in a chirp signal being fixed;
performing a second modeling operation of the chirp bandwidth in consideration of the idle time varying according to the chirp bandwidth;
determining a maximum chirp bandwidth based on the user parameter and a result of the second modeling operation; and
outputting, through an antenna, a chirp signal based on the maximum chirp bandwidth.

22. The operating method of claim 21, wherein the user parameter comprises at least one of a maximum detection range of a target object to be detected using the chirp signal, a maximum detection Doppler value of the target object, or a start frequency of the chirp signal.

23. The operating method of claim 21, further comprising:
defining a relationship between the chirp bandwidth and the idle time between the chirp pulses, based on a measurement of the idle time required based on the chirp bandwidth; and
setting a width of the chirp pulses as a function of the chirp bandwidth, based on the defined relationship,
wherein the performing the second modeling operation comprises performing the second modeling operation based on the width.

24. The operating method of claim 21, further comprising:
determining an initial chirp bandwidth based on a result of the first modeling operation; and
updating the initial chirp bandwidth, based on the initial chirp bandwidth and the defined relationship,
wherein the determining the maximum chirp bandwidth comprises determining the maximum chirp bandwidth based on the user parameter, the updated initial chirp bandwidth, and the result of the second modeling operation.

25. The operating method of claim 21, further comprising:
adjusting the maximum chirp bandwidth based on a configuration of a chirp signal generator of the device.

26. The operating method of claim 25, further comprising:
comparing a multiplication result between a sampling frequency of the chirp signal generator and a width of the chirp pulses with a size of a memory of the chirp signal generator; and
adjusting the maximum chirp bandwidth based on the comparing.

27. The operating method of claim 26, wherein the adjusting of the maximum chirp bandwidth comprises:
reducing the maximum chirp bandwidth by reducing the width of the chirp pulses and maintaining the sampling frequency.

28. The operating method of claim 26, wherein the adjusting of the maximum chirp bandwidth comprises:
reducing the maximum chirp bandwidth by reducing the sampling frequency and maintaining the width of the chirp pulses.
